(19) United States
(12) Patent Application Publication
(10) Pub. No.: US 2008/0159601 A1
(43) Pub. Date: Jul. 3, 2008

(54) Face Recognition System and Corresponding Method

(75) Inventors: WILLIAM P. ALBERTH, PRAIRIE GROVE, IL (US); SCOTT A. STEELE, SAN DIEGO, CA (US); LAWRENCE J. CHAPA, LIBERTYVILLE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/957,548

(22) Filed: Dec. 17, 2007

Related U.S. Application Data
(60) Provisional application No. 60/882,932, filed on Dec. 31, 2006.

(51) Int. Cl. G06K 9/00

(52) U.S. Cl. 382/118

(57) ABSTRACT

A face recognition system is provided, which is incorporated as part of traditionally worn items, so as to allow for face recognition assistance without being obvious to the person whose face is being recognized. The face recognition system includes a viewfinder, which has an image capture module and a display module, and includes a user actuatable selector. The face recognition system further includes a data storage element, which includes a data structure, having one or more images of faces of people, and associated identification information. The face recognition system still further includes a controller, where the controller is communicatively coupled to the viewfinder, the user actuatable selector, and the data storage element. The controller includes a pattern matching module, wherein when the user actuatable selector is activated the pattern matching module of the controller is adapted for comparing an image being currently captured by the image capture module with the one or more images of faces in the data structure, and wherein when the pattern matching module detects a match, the controller is adapted to retrieve the identification information associated with the matched image, and convey the identification information to the user.

### FIELD OF THE INVENTION

The present invention relates generally to a face recognition system and corresponding method, and more particularly, to a face recognition system, which is incorporated as part of traditionally worn items, so as to allow for assisted face recognition without the assistance being obvious to the person whose face is being recognized.

### BACKGROUND OF THE INVENTION

Many people have difficulty remembering names, which in some situations can create an awkward situation, and/or make it difficult for some of the people to enjoy social settings. Much of the time can sometimes be spent trying to recall the names of people they are likely to see, or phrasing greetings to avoid using a colleague's name that can not be immediately recalled, when the circumstances dictate the appropriateness of socially interacting with somebody whose name is not remembered, but whose name should be remembered.

While an inability to remember names can be difficult enough in more casual and/or social settings, in some instances it can be even more difficult in instances where one's job necessitates interacting with large numbers of people, where a familiarity and a friendly interaction is expected and/or professionally helpful. Furthermore, it may not just be names, but it may be beneficial to be able to recall other personal information, such as the name of a spouse and/or one's children, or other unique information, that might be used in a conversation to enhance a feeling of familiarity and camaraderie. Being able to remember personal details about an acquaintance can convey the perception of an empathetic nature, and/or can facilitate personally relevant small talk, which in turn can help better establish trust and goodwill.

For example, in some occupations one's success can be largely effected by one's ability to interact at a personal level, including such occupations as a salesman or a politician. However, in some instances, it may be beneficial to be able to identify faces of people who one has never previously met, such as a law enforcement agent, where it might be beneficial to be able to recognize the faces of people for whom an outstanding warrant exists.

However, much of the goodwill associated with remembering names or personal details would be lost if the other person was aware that the ability to recall the information was the result of an artificial system, which was supplying the information. Consequently, it would be beneficial if the face recognizer system could be incorporated in traditionally worn items, where the interaction with the system could be done in a more covert manner.

### SUMMARY OF THE INVENTION

The present invention provides a face recognition system. The face recognition system includes a viewfinder, which has an image capture module and a display module, and includes a user actuatable selector. The face recognition system further includes a data storage element, which includes a data structure, having one or more images of faces of people, and associated identification information. The face recognition system still further includes a controller, where the controller is communicatively coupled to the viewfinder, the user actuatable selector, and the data storage element. The controller includes a pattern matching module, wherein when the user actuatable selector is activated the pattern matching module of the controller is adapted for comparing an image being currently captured by the image capture module with the one or more images of faces in the data structure, and wherein when the pattern matching module detects a match, the controller is adapted to retrieve the identification information associated with the matched image, and convey the identification information to the user.

In at least one embodiment, the display module is an overlay display formed on a lens positioned in front of a user's eye.

In at least a further embodiment, the user actuatable selector includes a microphone adapted to detect an audible sound.

The present invention further provides a method for recognizing a face. The method includes detecting an image via an image capture module that is being worn by a user. The image detected by the image capture module is then displayed on a display module. The image capture module is then aimed at a face to be recognized. A user actuatable switch is then activated, when the face to be recognized is prominently positioned in the image being detected by the image capture module. The face to be recognized in the detected image is then compared with one or more images of pre-identified faces of people, which are stored in a data storage element in the form of a data structure. Each pre-identified face has identification information associated with the image stored in the data storage element. Upon detecting a match between the face to be recognized in the detected image, and one of the one or more images of pre-identified faces of people, the associated identification information of the matched one of the one or more images of pre-identified faces of people is communicated to the user.

The present invention further provides a contact lens. The contact lens includes an overlay display on the surface of the contact lens. The contact lens further includes an antenna adapted for receiving radiated energy. The contact lens still further includes a power regulation circuit, which is coupled to the antenna for receiving a nearby field of radiated energy and deriving power therefrom, and coupled to the overlay display for supplying power thereto. Further yet, the contact lens includes a communication circuit, which includes a receiver. The communication circuit is coupled to the power regulation circuit for receiving power therefrom, is coupled to the antenna for receiving a wireless communication signal containing image data, and is coupled to the overlay display for supplying the received image data to the overlay display.

These and other features, and advantages of this invention are evident from the following description of one or more preferred embodiments of this invention, with reference to the accompanying drawings.

### BRIEF DESCRIPTION OF THE DRAWINGS

FIG. 1 is a block diagram of a face recognition system, in accordance with at least one embodiment of the present invention;

FIG. 2 is a perspective view of a couple of traditionally worn items, within which some of the elements of the face recognition system can be incorporated;

FIG. 3 is a partial enlarged view of a pair of glasses, in accordance with at least one embodiment of the present invention;

FIG. 4 is a front plan view of a contact lens, in accordance with at least one embodiment of the present invention;

FIG. 5 is a side plan view of the contact lens, illustrated in FIG. 4;

FIG. 6 is a block diagram of a contact lens, in accordance with at least one embodiment of the present invention; and

FIG. 7 is a flow diagram of a method for recognizing a face, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

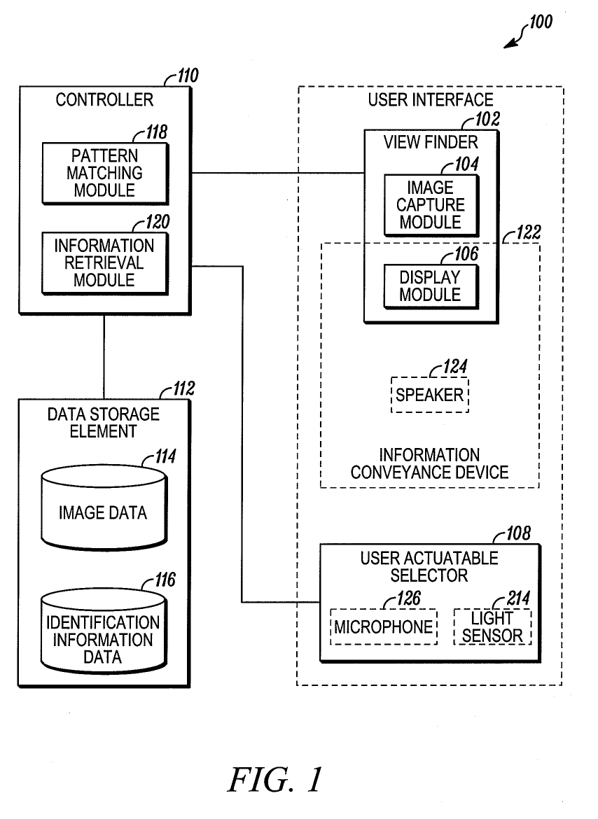

FIG. 1 illustrates a block diagram of a face recognition system 100, in accordance with at least one embodiment of the present invention. The face recognition system includes a view finder 102 incorporating an image capture module 104 and a display module 106. In at least some embodiments, the image capture module 104 includes a camera, or other device for capturing an image. The display module 106 is provided for displaying the image being currently detected by the image capture module 104. By displaying the image being currently detected by the image capture module 104, the display module 106 provides a mechanism by which the user can aim the image capture module 104, and confirm that the image being captured contains the face to be recognized. In at least some instances, the display module will be incorporated on the lens of some form of eyewear, such as a lens incorporated as part of a pair of glasses, or a pair of contact lenses. In at least some instances the display module will involve a liquid crystal display layer, or similar technology, which is overlaid onto at least a portion of the viewable lens. In this way the display will be located in a traditionally worn item, which enables the user to view the display without being conspicuous, as the lens of the corresponding item is in a form, which is traditionally placed in front of the user's eye.

The face recognition system 100 further includes a user actuatable selector 108, which can be used to indicate that the face to be recognized by the system is presently being captured by the image capture module 104. Upon actuation of the user actuatable selector 108, a signal is sent to a controller 110, which compares the image being currently captured with one or more prestored images contained in a data storage element 112. Generally the one or more prestored images will be contained in an organized data structure of image data 114 that links the one or more images with identification and/or other personal information data 116. More specifically, the controller 110 includes a pattern matching module which attempts to match the image of the face being currently captured to the one or more prestored images. One or more well known pattern recognition algorithm can be used, where preferably algorithms well suited to matching facial features will be selected.

In connection with matching the faces, the pattern matching module 118 may initially try to match all of the features. However upon failure to detect a match, the pattern matching module 118 may exclude features from the matching algorithm that can be more readily changed, and attempt to determine a match from a subset of the stored and captured features. For example, in the event that a match can not be found, the module may attempt to find a match excluding features associated with hair style, hair coloring or the presence or absence of facial hair, as such features can generally be more readily changed. However in at least some instances, instead of excluding the feature, a different weighting can be established and/or associated with each of the features. Features that can be changed more readily may be assigned a lower or discounted weighted value.

In attempting to perform a match a score can be assigned to each of the prestored images, whereupon finding a prestored image having a score that exceeds a predetermined threshold, a match may be indicated. In other instances, a score may be assigned to each of the prestored images and a search for the highest score may be used in further identifying the existence of a potential match.

Upon detecting a match, the information retrieval module 120, which forms part of the controller 110, will retrieve related identification information from the associated stored identification information data 116 associated with the matched image data 114. The retrieved identification information data 116 is then conveyed to the user via an information conveyance device 122. Along with the identification information data 116, the image data 114 associated with the match may also be conveyed, which might allow the user to manually confirm whether a match, in fact, is believed to have been found.

In at least some instances, the controller 110 will be implemented using one or more microprocessors, where the pattern matching module 118 and the information retrieval module 120 might be implemented using one or more sets of prestored instructions. However in some instances all or portions of the controller could be implemented in hardware, where exemplary forms include one or more sequential state machines and/or various logic circuitry, including discrete logic elements, programmable gate array elements, and/or VLSI circuitry. One skilled in the art will readily recognize that still further alternative implementations involving various forms of software programming and hardware elements can be used to implement the present invention without departing from the teachings of the present invention.

In some instances, the image data 114 and the associated identification information data 116 can be conveyed to the user via the display module 106. In other instances, a speaker 124 incorporated as part of an ear piece could be used to convey at least some of the information, such as the identification information in the form of a name. In this way, the proper pronunciation may be simultaneously conveyed to the user. It is further possible that some information may be conveyed by one type of information conveyance device 122 and other information may be conveyed by another type of information conveyance device 122. For example, it would be difficult to present the matching image data 114 to the user via a speaker 124, consequently the confirming image data 114 may be presented to the user via the display module 106, and the identification information data 116 may be conveyed to the user via the speaker 124.

In at least some instances, the user actuatable selector could include a microphone 126, which is adapted for detecting an audible command. In some instances the audible command may be voiced, which in some instances may be sub-vocalized. In other instance the command may be an unvoiced audible command, such as a teeth click, which might be detected by the microphone 126.

While the display module 106 has previously been identified as potentially being associated with eyewear, such as a pair of glasses and or a contact lens, to the extent that a microphone 126 and/or a speaker 124 may be used as part of the face recognition system 100, the microphone 126 and/or the speaker 124 could be incorporated as part of a wireless headset, such as a bluetooth earpiece. In turn, the wireless headset can communicate with another wireless communication device, which might contain a controller 110 and data storage element 112, such as a radio frequency telephone for use as part of the face recognition system 100. The radio frequency telephone having wider area communication capabilities might further be able to remotely access a data base, for example located on a server, which could contain all or some of the image data 114 and/or identification information data 116 to be used in association with the face recognition system. Many radio frequency telephones are further known to incorporate cameras and/or displays, which could also be used as the image capture module 104 and display module 106 of the viewfinder 102 in the present face recognition system 100.

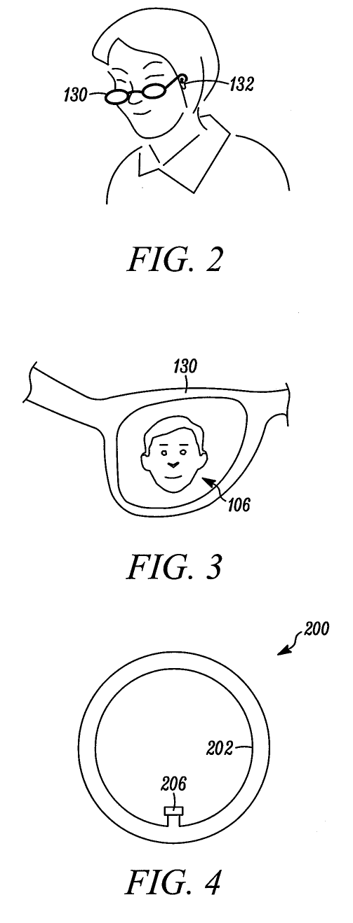

FIG. 2 illustrates a perspective view of a couple of traditionally worn items, within which some of the elements of the face recognition system 100 can be incorporated. For example as previously noted, the display module may be formed as part of the lens used for one or both of the eyes in a pair of glasses 130. Furthermore, as noted previously, the speaker 124 and/or the microphone 126 may be incorporated as part of an earpiece 132.

FIG. 3 illustrates a partial enlarged view of a pair of glasses, in accordance with at least one embodiment of the present invention, where the display module 106 might overlay the image being captured by the image capture module 104 on one or both of the lenses of eyewear (i.e. glasses 130). The eyewear may further incorporate other portions of the face recognition system including the image capture module, the controller and the data storage element. Furthermore the earpiece 132 incorporating a speaker 124 and/or a microphone 126 may similarly be incorporated as part of the eyewear.

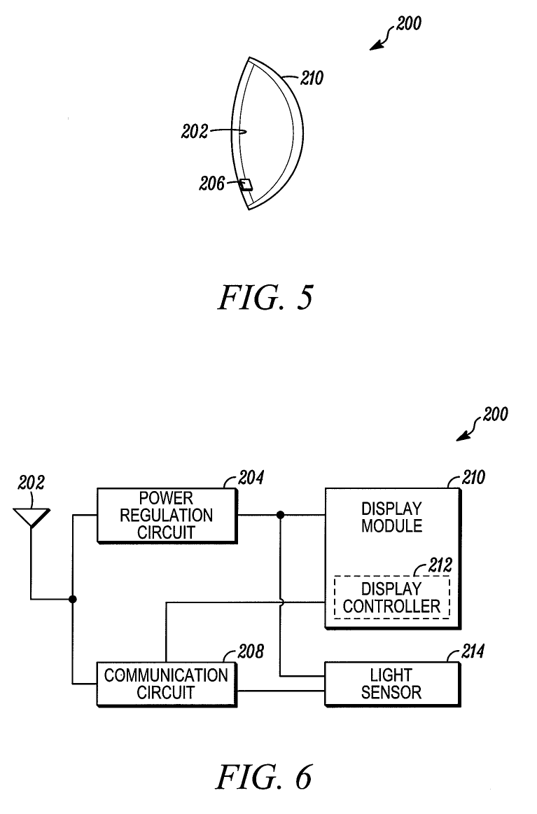

As noted previously, as opposed to a pair of glasses, the above noted eyewear may involve one or more contact lenses, which could incorporate the display module 106. FIGS. 4 and 5 illustrate a front and side plan view of a contact lens 200, in accordance with at least one embodiment of the present invention. In the illustrated embodiment, the contact lens includes an antenna 202 in the form of an inductive coil, which can be used to both derive power from a nearby electric field, and can be used to communicate wirelessly with other portions of the face recognition system. A power regulation circuit 204 on a small circuit substrate 206 could be embedded in the lens to support the derivation of power from the nearby electric field for powering other subsystems associated with the contact lens. A communication circuit 208 could similarly be located on the circuit substrate 206. A display module 210, such as liquid crystal display structure 210, or an E-Ink coating, could be overlaid all or a portion of the lens 200. The display module 106 could similarly receive operational power via the power regulation circuit 204. In the illustrated embodiment the display controller 212 is similarly located on the circuit substrate 206, where the display controller 212 receives the data for the image information to be displayed via the communication circuit 208.

FIG. 6 illustrates a block diagram of a contact lens 200, in accordance with at least one embodiment of the present invention, in accordance with the discussion noted above associated with FIGS. 4 and 5.

As illustrated in FIG. 6, the contact lens 200 could further incorporate a light sensor 214, which could be used to detect the presence or absence of light, which might result from an eye blink. The light sensor 214, similar to the power regulation circuit 204, the communication circuit 208, and the display controller 212, could also be located on the embedded circuit substrate 206. As a result of blinking one's eyes, the light sensor 214 can be used to trigger a user actuation, which in turn could be used to confirm that the face to be recognized is presently being captured by the image capture module 104, as identified by the image being conveyed to the user via the display module 106.

In at least some instances, the light sensor 214 may be incorporated in one of the pair of contact lenses, while the display module 210 is incorporated in the other one of the pair of contact lenses 200. In other instances, the light sensor 214 and the display module 210 may be integrated as part of the same contact lens 200. If light sensors are in both eyes, then the detection of blinking of either or both eyes individually, in combination, or together in predetermined patterns could be mapped to respective commands.

The light sensor may also take the form of a solar cell, which could provide power to the device, alternatively and/or in addition to providing a manner in which various blinking patterns and duration could be used as an input. For example, the display processor could detect an absence or a presence of a voltage at the output of the light sensor to determine if the eyes(s) are open or closed.

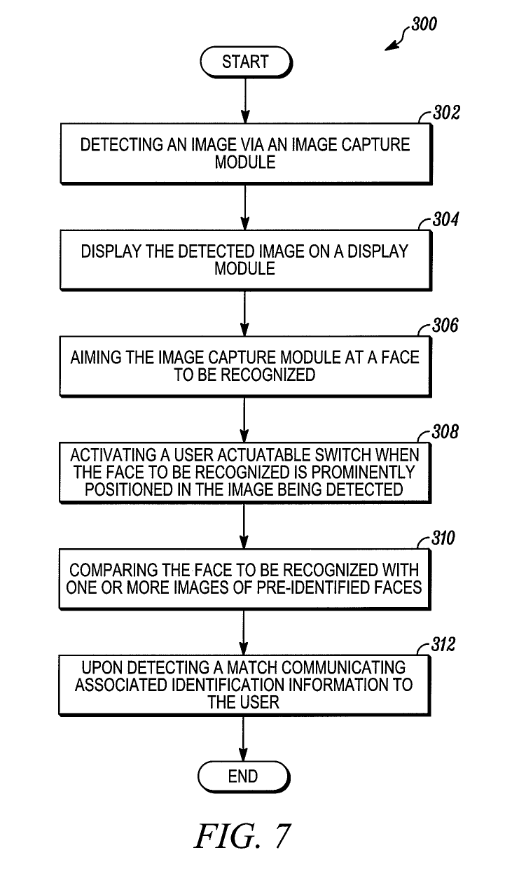

FIG. 7 illustrates a flow diagram of a method 300 for recognizing a face, in accordance with at least one embodiment of the present invention. The method includes detecting 302 an image via an image capture module. The detected image is then displayed 304 to the user via the display module. The image capture module is then aimed 306 at a face to be recognized. When the face to be recognized is prominately positioned in the image being detected, a user actuatable switch is then activated 308. The face to be recognized is then compared 310 with one or more pre-identified faces. Upon detecting a match, the identification information associated with the matched pre-identified faces is communicated 312 to the user.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A face recognition system comprising:
a viewfinder including a image capture module and a display module;
a user actuatable selector;
a data storage element including a data structure comprising one or more images of faces of people, and associated identification information; and
a controller communicatively coupled to the viewfinder, the user actuatable selector, and the data storage element, the controller including a pattern matching module, wherein when the user actuatable selector is activated the pattern matching module of the controller is adapted for comparing an image being currently captured by the image capture module with the one or more images of faces in the data structure, and wherein when the pattern matching module detects a match, the controller is adapted to retrieve the identification information associated with the matched image, and convey the identification information to the user.

2. A face recognition system in accordance with claim 1, wherein the image capture module is a camera.

3. A face recognition system in accordance with claim 1, wherein the display module is an overlay display formed on a lens positioned in front of a user's eye.

4. A face recognition system in accordance with claim 3, wherein the lens is formed as part of pair of glasses.

5. A face recognition system in accordance with claim 4, wherein the image capture module is a camera formed as part of the pair of glasses.

6. A face recognition system in accordance with claim 3, wherein the lens is formed as part of a contact lens.

7. A face recognition system in accordance with claim 3, wherein the lens includes a passive communication circuit, which derives power from a nearby field for supporting the communication of a radio frequency signal and for supplying power to the overlay display.

8. A face recognition system in accordance with claim 1, wherein the user actuatable selector includes a microphone adapted to detect a sound audible only to the user.

9. A face recognition system in accordance with claim 1, further comprising a speaker for conveying the identification information to the user in the form of an audible signal.

10. A face recognition system in accordance with claim 1, wherein further comprising a headset incorporating the user actuatable selector in the form of a microphone adapted to detect an audible sound, and incorporating a speaker for conveying the identification information to the user in the form of an audible signal.

11. A face recognition system in accordance with claim 10, wherein the headset includes a transceiver for wirelessly communicating a signal between the headset and the controller.

12. A face recognition system in accordance with claim 1, wherein the data storage element and the controller are incorporated as part of a wireless communication device.

13. A face recognition system in accordance with claim 12, wherein the wireless communication device is a cellular telephone.

14. A method of recognizing a face, the method comprising:
detecting an image via an image capture module being worn by a user;
displaying the image detected by the image capture module on a display module;
aiming the image capture module at a face to be recognized;
activating a user actuatable switch, when the face to be recognized is prominently positioned in the image being detected by the image capture module;
comparing the face to be recognized in the detected image with one or more images of pre-identified faces of people, which are stored in a data storage element in the form of a data structure, each pre-identified face having identification information associated with the image stored in the data storage element; and
upon detecting a match between the face to be recognized in the detected image, and one of the one or more images of pre-identified faces of people, communicating the associated identification information of the matched one of the one or more images of pre-identified faces of people to the user.

15. A method of recognizing a face in accordance with claim 14, wherein the associated identification information is communicated to the user via the display module.

16. A method of recognizing a face in accordance with claim 14, wherein the associated identification information is communicated to the user via a speaker proximate the user's ear.

17. A contact lens comprising:
an overlay display on the surface of the contact lens;
an antenna adapted for receiving radiated energy;
a power regulation circuit coupled to the antenna for receiving a nearby field of radiated energy and deriving power therefrom, and coupled to the overlay display for supplying power thereto;
a communication circuit including a receiver, where the communication circuit is coupled to the power regulation circuit for receiving power therefrom, coupled to the antenna for receiving a wireless communication signal containing image data, and coupled to the overlay display for supplying the received image data to the overlay display.

18. A contact lens comprising:
a light sensor for detecting a pattern of the presence and absence of detected light; and
a controller coupled to the light sensor, wherein the controller is adapted to receive the pattern and match the pattern to one or more prestored patterns associated with respective commands to be received or actions to be performed by the controller.

19. A contact lens in accordance with claim 18, where the light sensor is a solar cell that is adapted to provide power to one or more circuit elements including the controller.
